(19) United States
(12) Patent Application Publication
(10) Pub. No.: US 2026/0146630 A1
(43) Pub. Date: May 28, 2026

(54) TELESCOPIC CYLINDER WITH VARIABLE VOLUME FEED CHANNELS AND CYLINDER CONTROL

(71) Applicant: MANITOU ITALIA S.R.L., CASTELFRANCO EMILIA (MODENA) (IT)

(72) Inventor: MARCO IOTTI, REGGIO EMILIA (IT)

(21) Appl. No.: 19/399,915

(22) Filed: Nov. 25, 2025

(30) Foreign Application Priority Data
Nov. 26, 2024 (IT) 102024000026637

(51) Int. Cl. F15B 15/16; F15B 19/00

(52) U.S. Cl. CPC F15B 15/16; F15B 19/00

(57) ABSTRACT

A telescopic cylinder that includes a first cylinder having a first piston slidable in a sealed fashion in a jacket which has an extension chamber and a re-entry chamber, separated from each other by a head of the first piston. A second cylinder of the cylinder has a second piston slidable in a sealed fashion in a jacket which includes an extension chamber and a re-entry chamber, separated from each other by a head of the second piston. The jacket of the first piston is integral with the second piston and a conduit for connection to the extension chamber of the second cylinder is made at least partly through the first piston and the second piston. A compensating device is provided with a control module configured for adjusting a flow rate of operating fluid to be fed to or discharged from the extension chamber.

### DESCRIPTION

This invention relates to a telescopic cylinder provided with a compensating device and a method for controlling said telescopic cylinder.

The invention may be used, but not exclusively, for actuating a telescopic arm used in an operating machine, such as, for example, a telehandler, manipulator, lift truck, aerial platform, both of the fixed type and of the rotary type.

These operating machines are used in various sectors, from building works, to farming, to mining, etc. and include a vehicle provided with a frame movable on tracks or on wheels, which mounts a driver's cab and a lifting arm which can be extended telescopically.

At the distal end of the arm there is an apparatus for lifting or moving loads, which comprises a tool such as a fork, a gripper, etc.

The arm is articulated to the frame or to a rotary platform of the machine and is designed to rotate from a lower position, substantially horizontal, to an upper position wherein the arm is close to the vertical. The rotation of the arm is achieved by means of actuators such as hydraulic cylinders or the like. The arm comprises two or more sliding segments, tubular in shape and with a decreasing cross-section, which are connected in a telescopic fashion. Solutions are known wherein at least the first two sliding members of the arm, that is to say, the sliding member closest to the axis of rotation of the arm and the sliding member immediately following it, are slidably driven by a telescopic cylinder with double sliding member. These solutions use a telescopic cylinder comprising a first cylinder and a second cylinder, wherein the piston of the second cylinder houses the sliding chamber of the piston of the first cylinder. The two cylinders are fed independently of each other so that each can slide independently of each other. The possibility of controlling the two sliding members independently may be useful, for example, for moving the overall barycentre of the arm under certain conditions of use.

In the solutions wherein the telescopic arm adopts a significant length, the prior art teaches structuring the feed circuit for the telescopic cylinder with inner conduits, that is to say, conduits which are made in the thickness of the pistons. That is because if the conduits were external, they would need to have a considerable length, resulting in a number of drawbacks in terms of space occupied and support for the conduits.

In some of the solutions currently available, the feed circuit to the second cylinder, that is, to the cylinder whose piston houses the sliding chamber of the piston of the first cylinder, comprises an inner conduit made in the thickness of the piston of the first cylinder, which emerges in a respective chamber of the first cylinder. In the cases in which only the first cylinder is operated in extension, whilst the second cylinder is maintained inactive, the inner feed conduit to the second cylinder increases in length, and therefore increases in volume. This results in a drop in pressure inside the corresponding chamber of the second cylinder; this drop in pressure may lead to an unexpected movement of the second cylinder, which may result in problems of stability and safety of the arm, as well as to errors in the operation of the apparatus connected to the telescopic arm.

The aim of this invention is to provide a telescopic cylinder and the related control method which allow the drawbacks of the devices currently available to be overcome.

One advantage of this invention is that it allows the position of each cylinder to be stably maintained if the other cylinder is operated independently.

Another advantage of the cylinder according to this invention is that it is compact and can be easily installed in prior art operating machines, without the need for complex structural adaptations.

Further features and advantages of the invention are more apparent from the detailed description which follows of an embodiment of the invention, illustrated by way of a non-limiting example in the accompanying drawings in which:

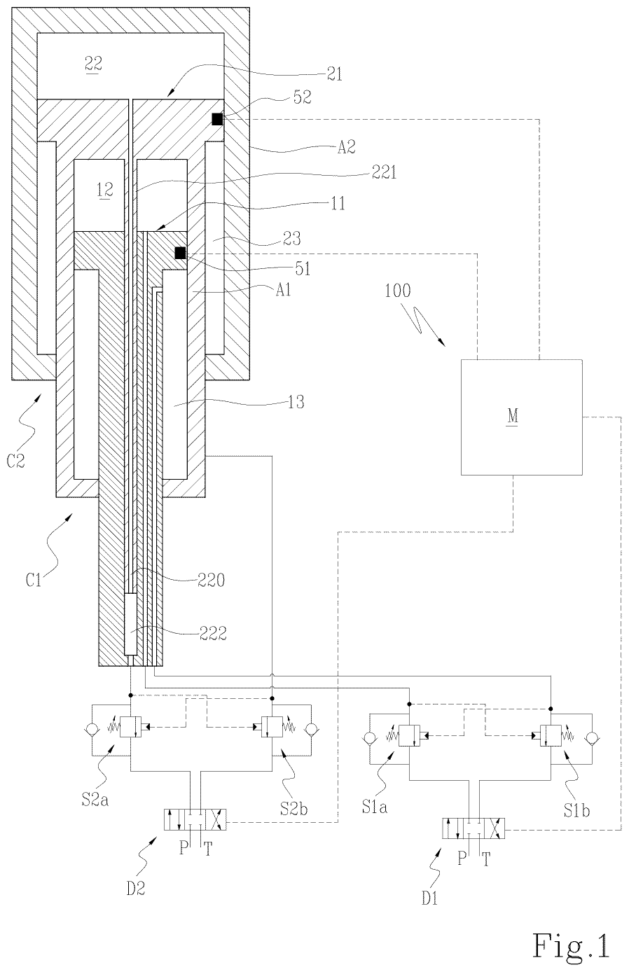

FIG. 1 is a schematic illustration of the telescopic cylinder according to the invention, connected to a feed circuit;

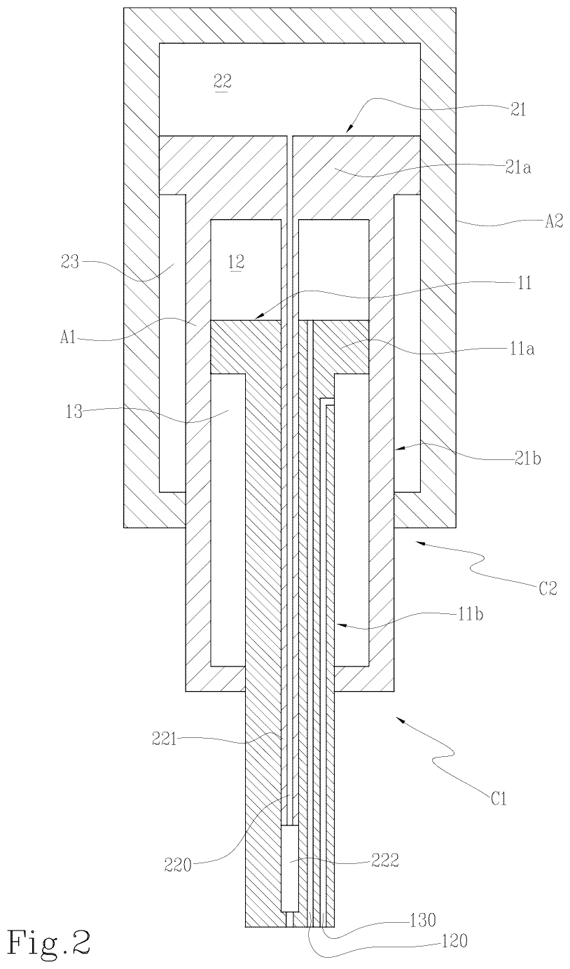

FIG. 2 shows an enlarged view of the telescopic cylinder according to the invention.

The solution described in this invention relates to a telescopic cylinder which comprises a first cylinder (C1) and a second cylinder (C2) fed independently of each other. The solution might, however, also be extended to telescopic cylinders comprising a greater number of cylinders fed independently of each other.

The telescopic cylinder according to this invention comprises a first cylinder (C1) and a second cylinder (C2), connected telescopically to each other. Preferably, the first cylinder (C1), comprises a first piston (11) slidable in a sealed fashion in a jacket (A1) which comprises an extension chamber (12) and a re-entry chamber (13), separated from each other by a head (11a) of the first piston (11). In a manner known in the sector, the first piston (11) comprises a rod (11b), connected to the head (11a) and protruding outside the jacket (A1). The rod (11b) is designed to be connected to a fixed part of the machine. The feeding of pressurised operating fluid to the extension chamber (12) results in a movement of the rod (11b) coming out from the jacket (A1), whilst the feeding of pressurised operating fluid to the re-entry chamber (13) results in a movement of the rod (11b) re-entering the jacket (A1).

The second cylinder (C2), comprises, in turn, a second piston (21) slidable in a sealed fashion in a jacket (A2) which comprises an extension chamber (22) and a re-entry chamber (23), separated from each other by a head (21a) of the second piston (21). The jacket (A1) of the first piston (11) is integral with the second piston (21). In particular, the jacket (A1) of the first piston (11) forms at least partly a rod (21b) of the second piston (21), which protrudes from the jacket (A2) of the second cylinder (C2). The feeding of pressurised operating fluid to the extension chamber (22) results in a movement of the rod (21b) coming out from the jacket (A2), whilst the feeding of pressurised operating fluid to the re-entry chamber (23) results in a movement of the rod (21b) re-entering the jacket (A1).

Both of the pistons (11, 21) are concentric to a longitudinal axis (X) and are movable relative to each other along the longitudinal axis (X).

The extension and re-entry chambers (12, 13) of the first cylinder (C1) are connected to a feed circuit of known type, which comprises, for example, a proportional four-way distributor (D1), designed to determine the feeding of oil to the extension chamber (12) or the re-entry chamber (13) and, simultaneously, to put in communication with a drain the chamber which is not fed with the oil. In the embodiment illustrated, the distributor (D1) is provided with a drawer or shutter which may adopt an extension position, in which the extension chamber (12) is in communication with a source of high pressure fluid, for example a pump (P), and the re-entry chamber (13) is in communication with a drain. This first position is schematically shown on the left-hand side of the distributor (D1). The drawer may also adopt a re-entry position, schematically illustrated on the right-hand side of the distributor (D1), in which opposite connections are made relative to those of the first position. The drawer may also adopt a central position in which the chambers (12, 13) are not in communication with the pump (P). The circuit also comprises two valves for controlling the load (S1a, S1b), of known type, connected, respectively, to the extension chamber (12) and to the re-entry chamber (13), designed to allow the discharge of oil from the respective chamber (12, 13) only in the presence of a specific command which moves them into an open configuration. According to the embodiment described, the specific command is obtained in the form of a control pressure picked up from a branch of the circuit connected to the opposite chamber 12, 13.

The extension and re-entry chambers (22, 23) of the second cylinder (C2) are connected to a feed circuit similar to that described above, with a distributor (D2) and load control valves (S2a, S2b) similar and operational as described above in relation to the first cylinder (C1).

Each distributor (D1, D2) can be activated independently of the other, so that each cylinder (C1, C2) can be controlled independently from the other.

In a manner known in the sector, the commands for extension and re-entry of each cylinder may be issued using an operating unit or an interface which can be activated by an operator. The operating unit comprises, for example, an electric joystick, one or more pushbuttons or the like. The extension or re-entry command causes the movement of the respective distributor (D1, D2) to the position corresponding to the requested action. The commands sent to the proportional distributors (D1, D2) may be of any type, for example of the electro-hydraulic type, for controlling a control pressure, or direct electrical type.

According to the embodiment illustrated, the extension chamber (12) of the first cylinder (C1) is connected to the feed circuit by a first conduit (120), made through the first piston (11). The re-entry chamber (13) of the first cylinder (C1) is connected to the feed circuit by a second conduit (130), also made through the first piston (11).

According to the preferred but not exclusive embodiment illustrated, the re-entry chamber (23) of the second cylinder (C2) is connected to the feed circuit of the second cylinder (C2) by an outer conduit, schematically illustrated in FIG. 1.

The telescopic cylinder also comprises a first conduit (220) for connection to the extension chamber (22) of the second cylinder (C2). The connecting conduit (220) is made at least partly through the first piston (11) and the second piston (21). According to the embodiment illustrated, the connecting conduit (220) comprises a tubular element (221), integral with the second piston (21) and protruding concentrically with the longitudinal axis (X) through the first piston (11). The latter has a seat (222) in which the tubular body can slide in a sealed fashion. The seat (222), in turn, has an opening for connection to the feed circuit of the second cylinder (C2).

The feeding of operating fluid to the extension chamber (12) of the first cylinder (C1) results in a relative sliding between the tubular element (221) and the seat (222) which increases the free volume of the seat (222). In the absence of the solution described below, the increase in the free volume of the seat (222) would result in a significant drop in pressure in the extension chamber (22) of the second cylinder (C2).

In any case, this invention may be advantageously used in solutions wherein the cylinders are served by feed/discharge conduits outside or inside the cylinders, wherein the conduits can all be external or all internal, or also partly external and partly internal. The invention is particularly useful for feed/discharge conduits with a variable volume as a function of the volume variation of the chamber to which they are connected.

The telescopic cylinder according to the invention comprises a compensating (100), provided with a control module (M) configured for adjusting a compensating flow rate of operating fluid to be fed to the extension chamber (22) or discharged from the extension chamber (22) of the second cylinder (C2) as a function of a variation of volume per unit time of the extension chamber (12) of the first cylinder (C1).

In short, the control module (M) is configured for adjusting a flow rate of compensating operating fluid to be fed to the extension chamber (22) or discharged from the extension chamber (22) of the second cylinder (C2), as a function of a flow rate of operating fluid fed to the extension chamber (12) or discharged from the extension chamber (12) of the first cylinder (C1).

The compensating device (100) makes it possible to obtain an extremely advantageous technical effect. In effect, it allows for compensating for any disturbances to the state from the extension chamber (22) of the second cylinder (C2) due to a variation in volume per unit time of the extension chamber (12) of the first cylinder (C1), allowing the volume of the extension chamber (22) of the second cylinder (C2) to be maintained substantially unchanged, and therefore the position of the second piston (21). For example, in an operating condition wherein the operating fluid is fed to the extension chamber (12) of the first cylinder (C1) to obtain an extension of the first cylinder (C1), in the extension chamber (22) of the second cylinder (C2) there is a drop in pressure, due to the increase in volume of the extension chamber (22) due to the effect of the increase in volume of the seat (222) of the conduit (220). In these conditions, the compensating device (100) determines the sending of a predetermined compensating flow rate of operating fluid, as a function of the control flow rate sent for moving the first cylinder (C1). According to a possible embodiment, the compensating flow rate is adjusted to annul a pressure variation which is produced inside the expansion chamber (22) of the second cylinder (C2), so that the volume of the expansion chamber (22) remains substantially unaltered, maintaining the second cylinder (C2) stationary relative to the first cylinder (C1).

According to the preferred but not exclusive embodiment illustrated, the control module (M) adjusts and actuates the sending of operating fluid by activating the distributors (D1, D2) feeding the two cylinders (C1, C2). As already mentioned, the two distributors (D1, D2) can be activated independently of each other.

According to a possible embodiment, in the presence of a flow rate of fluid fed to the extension chamber (12) of the first cylinder (C1), the control module (M) is set up for measuring a variation in volume per unit time of the extension chamber (12) of the first cylinder (C1), and for feeding to the extension chamber (22) of the second cylinder (C2) a compensating flow rate of operating fluid corresponding to said variation in volume per unit time. This allows the volume of the extension chamber (22) to be kept substantially unaltered, so that the second cylinder (C2) remains stationary relative to the first cylinder (C1). The control performed by the control module (M), in the case described above, is an open loop control, performed substantially as a function of the variation in volume per unit time of the extension chamber (12) of the first cylinder (C1).

Advantageously, but not necessarily, the control module (M) may be provided with a control matrix wherein the predetermined flow rate values fed to the extension chamber (12) of the first cylinder (C1) correspond to respective compensating flow rate values. The control matrix can be obtained experimentally, through a test cycle which comprises feeding the extension chamber (12) of the first cylinder (C1) with a known flow rate, and feeding to the extension chamber (22) of the second cylinder (C2) a variable flow rate until obtaining a desired effect, such as, for example, a stabilisation of the volume of the extension chamber (22) of the second cylinder (C2). The flow rate value fed to the extension chamber (22) of the second cylinder (C2) which allows the desired effect to be obtained is the compensating flow rate corresponding to the flow rate fed to the extension chamber (12) of the first cylinder (C1). By repeating the test cycle described above for a certain set of flow rates fed to the extension chamber (12) of the first cylinder (C1) it is possible to construct the control matrix to be provided to the control module (M). The number of values present in the control matrix can be increased by known interpolation methods.

The use of a control matrix makes it substantially possible to lighten the calculation volume which the control module (M) must perform. This is because the control module (M) need not detect and assess the variation in volume of the extension chamber (12) of the first cylinder (C1), but it must simply identify the compensating flow rate value corresponding to the flow rate fed to the extension chamber (12) of the first cylinder (C1).

According to another possible embodiment, the control module (M) is configured to perform a feedback control. Preferably, but not necessarily, the feedback control is performed as a function of the open loop control described above. For this purpose, the control module (M) is designed for measuring a variation in volume per unit time of the extension chamber (22) of the second cylinder (C2), and for modifying the compensating flow rate in such a way as to annul the variation in volume in the unit of time of the extension chamber (22) of the second cylinder (C2). In other words, according to this embodiment, the control module (M) assesses, at predetermined moments in time, the effect produced by the compensating flow rate on the volume of the extension chamber (22) of the second cylinder (C2). If the volume of the extension chamber (22) remains unchanged, it means that the effect produced by the compensating flow rate is the desired one, and the compensating flow rate is not modified. If, on the other hand, the volume of the extension chamber (22) of the second cylinder (C2) varies, then the compensating flow rate is corrected to oppose and correct the variation in volume per unit time of the extension chamber (22). The compensating flow rate could be increased or reduced, depending on a reduction or an increase in the volume of the extension chamber (22) of the second cylinder (C2).

According to the embodiment described above, the control module (M) can be configured in such a way as to adjust the flow rate of oil fed to the extension chamber (22) of the second cylinder (C2) or discharged from the extension chamber (22) of the second cylinder (C2) not only as a function of the maintaining of the volume of the extension chamber (22) but also on the basis of a predetermined relationship between the speeds of movement of the first cylinder (C1) and the second cylinder (C2), that is, between the speeds of movement of the first piston (11) and the second piston (21). For example, it is possible to control the compensating flow rate in such a way that the second piston (21) moves at a predetermined speed relative to the first piston (11), that is to say, at the same speed, at a higher or lower speed, depending on requirements.

According to a further possible embodiment, the control module (M) is configured to operate as a function of the variation in volume per unit time of the extension chamber (22) of the second cylinder (C2). According to this embodiment, the presence of a flow rate of fluid fed to the extension chamber (12) of the first cylinder (C1), the control module (M) is set up for measuring a variation in volume per unit time of the extension chamber (22) of the second cylinder (C2), and for feeding or picking up at the extension chamber (22) of the second cylinder (C2) a flow rate of operating fluid in such a way as to annul said variation in volume per unit time. In this case, the control module (M) operates to keep constant the volume of the extension chamber (22) of the second cylinder (C2).

For detecting and measuring the volumes of the chambers (21, 22) used by the control module (M) to perform the controls described above, the compensating device (100) comprises an internal movement detector (51) designed to detect and quantify a relative movement between the first piston (11) and the first jacket (A1). The detecting and quantifying of a relative movement between the first piston (11) and the first jacket (A1), knowing the diameter of the extension chamber (12) of the first cylinder (C1), allows the variation in volume per unit time of the extension chamber (12) to be quantified. The internal movement detector (51) is connected to the control module (M), to send to the latter a signal signifying the relative movement between the first piston (11) and the first jacket (A1).

Preferably, the compensating device (100) comprises an external movement detector (52), designed to detect and quantify a relative movement between the second piston (21) and the second jacket (A2). As for the internal movement detector (51), the detection and quantification of a relative movement between the second piston (21) and the second jacket (A2), knowing the diameter of the extension chamber (22) of the second cylinder (C2), allows the variation in volume per unit time of the extension chamber (12) to be quantified. The external movement detector (52) is connected to the control module (M), to send to the latter a signal signifying the relative movement between the second piston (21) and the second jacket (A2).

In a possible use of the telescopic cylinder according to this invention, the second cylinder (C2) is connected by a kinematic mechanism to one or more telescopic sliding members of a telescopically extensible operating arm. In short, the telescopic sliding members are connected to the second cylinder (C2) by a series of linkage devices, configured in such a way that the extension or re-entry of the second cylinder (C2) also produces, through said linkage devices, the extension or re-entry of the telescopic sliding members. In that case, the external movement sensor (52) may be configured to detect and quantify a relative movement between the distal end of the telescopic arm and a predetermined reference point, for example the proximal end of the arm. In that case, the control module (M) is configured for obtaining the relative movement between the second piston (21) and the second jacket (A2) from the movement of the distal end of the arm, knowing the geometrical characteristics and the dimensions of the sliding members.

In a further possible embodiment of the invention, the control module (M) is configured for adjusting the compensating flow rate in such a way as to keep constant the pressure inside the extension chamber (22) of the second cylinder (C2). This compensates for the drop in pressure described above in the extension chamber (22) of the second cylinder (C2) due to the feeding of the operating fluid to the extension chamber (12) of the first cylinder (C1). In effect, as already mentioned, the feeding of the operating fluid to the extension chamber (12) of the first cylinder (C1) results in a relative sliding between the tubular element (221) and the seat (222) which increases the free volume of the seat (222). In the absence of this invention, the increase in the free volume of the seat (222) would result in a significant drop in pressure in the extension chamber (22) of the second cylinder (C2). The control module (M), detecting this pressure drop, supplies a compensating flow rate adjusted in such a way as to keep constant the pressure in the extension chamber (22) of the second cylinder (C2). For this purpose, the telescopic cylinder according to this invention is provided with a pressure sensor, designed for measuring the pressure in the extension chamber (22) of the second cylinder (C2). The pressure sensor may replace the movement detectors (51, 52) since, in this embodiment, the control module (M) does not need to be know either the variation in volume of the extension chamber (22) of the second cylinder (C2), or the variation in volume of the extension chamber (12) of the first cylinder (C1), but only the occurrence of the feeding of the operating fluid to the extension chamber (12) of the first cylinder (C1). In other words, the control module (M) is configured for detecting the presence of a flow rate of fluid fed to the extension chamber (12) of the first cylinder (C1) and, in that case, measuring the pressure in the extension chamber (22) of the second cylinder (C2) and feeding to the extension chamber (22) of the second cylinder (C2) a compensating flow rate adjusted to keep constant the pressure in the extension chamber (22) of the second cylinder (C2).

The compensating device (100) allows a control method to be actuated for the telescopic cylinder according to this invention which comprises the following steps:

detecting and quantifying a variation in volume per unit time of the extension chamber (12) of the first cylinder (C1);

feeding a compensating flow rate of operating fluid to the extension chamber (22) or discharging a compensating flow rate of operating fluid from the extension chamber (22) of the second cylinder (C2);

adjusting said compensating flow rate as a function of the variation in volume per unit time of the extension chamber (12) of the first cylinder (C1).

In the presence of a flow rate of fluid fed to the extension chamber (12) of the first cylinder (C1), the step of adjusting said compensating flow rate preferably comprises the steps of:

measuring a variation in volume per unit time of the extension chamber (12) of the first cylinder (C1);

feeding to the extension chamber (22) of the second cylinder (C2) a compensating flow rate of operating fluid corresponding to said variation in volume per unit time.

Preferably, but not necessarily, the method comprises measuring a variation in volume per unit time of the extension chamber (22) of the second cylinder (C2), and modifying the compensating flow rate in such a way as to annul said variation in volume per unit time of the extension chamber (22) of the second cylinder (C2).

In the presence of a flow rate of fluid fed to the extension chamber (12) of the first cylinder (C1), the method comprises preferably, but not necessarily, measuring a variation in volume per unit time of the extension chamber (22) of the second cylinder (C2), and for feeding or picking up at the extension chamber (22) of the second cylinder (C2) a compensating flow rate of operating fluid in such a way as to annul said variation in volume.

Preferably, said step of detecting and quantifying a variation in volume per unit time of the extension chamber (12) of the first cylinder (C1) comprises a step of detecting and quantifying a relative movement per unit time between the first piston (11) and the first jacket (A1).

Preferably, said step of detecting and quantifying a variation in volume per unit time of the extension chamber (22) of the second cylinder (C2) comprises a step of detecting and quantifying a relative movement per unit time between the second piston (11) and the second jacket (A2).

1. A telescopic cylinder, comprising:
a first cylinder, comprising a first piston slidable in a sealed fashion in a jacket which comprises an extension chamber and a re-entry chamber, separated from each other by a head of the first piston;
a second cylinder, comprising a second piston slidable in a sealed fashion in a jacket which comprises an extension chamber and a re-entry chamber, separated from each other by a head of the second piston;
wherein the jacket of the first piston is integral with the second piston;
wherein it comprises a compensating device, provided with a control module configured for adjusting a compensating flow rate of operating fluid to be fed to the extension chamber or discharged from the extension chamber of the second cylinder as a function of a variation of volume per unit time of the extension chamber of the first cylinder.

2. The telescopic cylinder according to claim 1, wherein the control module is provided with a control matrix wherein predetermined flow rate values to be fed to the extension chamber of the first cylinder correspond with respective compensating flow rate values to be fed to the extension chamber of the second cylinder.

3. The telescopic cylinder according to claim 1, wherein, in the presence of a flow rate of fluid fed to the extension chamber of the first cylinder, the control module is set up for measuring a variation in volume per unit time of the extension chamber of the first cylinder, and for feeding to the extension chamber of the second cylinder a compensating flow rate of operating fluid corresponding to said variation in volume.

4. The telescopic cylinder according to claim 2, wherein the control module is designed for measuring a variation in volume per unit time of the extension chamber of the second cylinder and for modifying said compensating flow rate in such a way as to annul said variation in volume of the extension chamber of the second cylinder.

5. The telescopic cylinder according to claim 1, wherein, in the presence of a flow rate of fluid fed to the extension chamber of the first cylinder, the control module is set up for measuring a variation in volume per unit time of the extension chamber of the second cylinder, and for feeding or picking up at the extension chamber of the second cylinder a flow rate of operating fluid in such a way as to annul said variation in volume.

6. The telescopic cylinder according to claim 1, wherein said control module comprises an internal movement detector set up for detecting and quantifying a relative movement between the first piston and the first jacket.

7. The telescopic cylinder according to claim 1, wherein the control module comprises an external movement detector set up for detecting and quantifying a relative movement between the second piston and the second jacket.

8. The telescopic cylinder according to claim 1, comprising a conduit for connection to the extension chamber of the second cylinder which is made at least partly through said first piston and said second piston.

9. The telescopic cylinder according to claim 8, wherein the connecting conduit comprises a tubular element, integral with the second piston and protruding concentrically with the longitudinal axis in a seat of the first piston.

10. The telescopic cylinder according to claim 1, wherein the control module is configured for adjusting said compensating flow rate in such a way as to keep constant the pressure inside the extension chamber of the second cylinder.

11. A method for controlling a telescopic cylinder, wherein the telescopic cylinder comprises:
a first cylinder, comprising a first piston slidable in a sealed fashion in a jacket which comprises an extension chamber and a re-entry chamber, separated from each other by a head of the first piston;
a second cylinder, comprising a second piston slidable in a sealed fashion in a jacket, integral with the jacket of the first cylinder, which comprises an extension chamber and a re-entry chamber, separated from each other by a head of the second piston;
comprising the following steps:
detecting and quantifying a variation in volume per unit time of the extension chamber of the first cylinder;
feeding a compensating flow rate of operating fluid to the extension chamber or discharging a compensating flow rate of operating fluid from the extension chamber of the second cylinder;
adjusting said compensating flow rate as a function of the variation in volume per unit time of the extension chamber of the first cylinder.

12. The method according to claim 10, wherein, in the presence of a flow rate of fluid fed to the extension chamber of the first cylinder, the step of adjusting said compensating flow rate comprises the steps of:
measuring a variation in volume per unit time of the extension chamber of the first cylinder;
feeding to the extension chamber of the second cylinder compensating flow rate of operating fluid corresponding to said variation in volume per unit time.

13. The method according to claim 11, comprising the following steps:
measuring a variation in volume per unit time of the extension chamber of the second cylinder;
modifying the compensating flow rate in such a way as to annul said variation in volume per unit time of the extension chamber of the second cylinder.

14. The method according to claim 10, comprising the following steps:
in the presence of a flow rate of fluid fed to the extension chamber of the first cylinder, measuring a variation in volume per unit time of the extension chamber of the second cylinder;
feeding or picking up at the extension chamber of the second cylinder a compensating flow rate of operating fluid in such a way as to annul said variation in volume.

15. The method according to claim 10, wherein said step of detecting and quantifying a variation in volume per unit time of the extension chamber of the first cylinder comprises a step of detecting and quantifying a relative movement per unit time between the first piston and the first jacket.

16. The method according to claim 10, wherein said step of detecting and quantifying a variation in volume per unit time of the extension chamber of the second cylinder comprises a step of detecting and quantifying a relative movement per unit time between the second piston and the second jacket.
